(19) United States
(12) Patent Application Publication
(10) Pub. No.: US 2001/0001645 A1
(43) Pub. Date: May 24, 2001

(54) WASTE GAS TREATMENT SYSTEM OF A SEMICONDUCTOR DEVICE FABRICATION FACILITY AND HAVING WET AND DRY TREATMENT UNITS INTEGRATED BY A GAS SEPARATION UNIT

(76) Inventors: SUNG-JAE LEE, SEOUL (KR); JIN-HEE LEE, SEOUL (KR); SOK-HO YI, KYUNGKI-DO (KR)

Correspondence Address: JONES & VOLENTINE, SUITE 150, 12200 SUNRISE VALLEY DRIVE, RESTON, VA, 20191

(21) Appl. No.: 09/172,148

(22) Filed: Oct. 14, 1998

(30) Foreign Application Priority Data
Dec. 8, 1997 (KR) 97-66721

(51) Int. Cl. B01J 8/00

(52) U.S. Cl. 422/170; 422/171; 422/173; 422/198; 422/93; 422/168; 423/210; 423/243.01; 423/240 S

(57) ABSTRACT

A waste gas treatment system treats waste gases of the type produced during the manufacture of semiconductor devices and therefore having different chemical characteristics. Based on the size of the particles of the waste gases, a gas separation unit discriminates waste gas that is best-suited for wet treatment from waste gas best-suited for dry treatment. A wet treatment unit is connected to one outlet of the gas separation unit, and a dry treatment unit is connected to another outlet of the gas separation unit. On the other hand, both the wet treatment unit and the dry treatment unit are connected to a water spray unit. The water spray unit treats the waste gases, which have passed through either the wet treatment unit or the dry treatment unit, so as to treat the waste gas for untreated water-soluble components.

### BACKGROUND OF THE INVENTION

1. Field of the Invention

The present invention relates to a waste gas treatment system of a semiconductor device fabrication facility. More particularly, the present invention relates to a waste gas treatment system for treating waste gases, having different chemical characteristics, discharged from a semiconductor device fabrication facility.

2. Description of the Related Art

Semiconductor devices are generally manufactured by carrying out various processes including a deposition process, an ion-implanting process, and an etching process. Each of such processes uses a gas specific to that process. The waste gases produced by any one of these processes includes reaction gas and non-reaction gas, each of which has a certain degree of toxicity, volatility, and corrosiveness, etc. These waste gases must therefore be discharged only after they have been treated to reduce the hazardous characteristics thereof.

Known methods of treating the waste gases can be classified as wet or dry treatments. The wet treatment neutralizes the acidity or alkalinity of the waste gases, and removes those compositions which are water soluble. On the other hand, the dry treatment decomposes the waste gases using some disposable material.

Because the various waste gases have different chemical characteristics, various types of waste gas treatment systems must be employed to treat all of the waste gases produced during the semiconductor fabrication process. In particular, discrete auxiliary wet and dry treatment systems have been conventionally employed in connection with a single semiconductor fabrication facility. The expenses associated with the treatment of the waste gases are accordingly great.

### SUMMARY OF THE INVENTION

An object of the present invention is to overcome one or more of the problems, limitations and disadvantages of the related art.

More specifically, an object of the present invention is to provide a single waste gas treatment system capable of treating the various kinds of waste gases, having different chemical characteristics, which are discharged from a semiconductor device fabrication facility.

To achieve this object, the present invention provides a waste gas treatment system of a semiconductor device fabrication process which comprises an integrated wet treatment unit and dry treatment unit. A gas separation unit discriminates and keeps separate the various kinds of waste gases discharged from processing chambers of the semiconductor device fabrication facility. The wet treatment unit is connected to one outlet of the gas separation unit for treating certain ones of the waste gases discriminated by the gas separation unit. The dry treatment unit is connected to another outlet of the gas separation unit for treating the waste gas selected for dry treatment by the gas separation unit. A water spray unit is connected to both the wet treatment unit and the dry treatment unit in order to further treat the waste gases which have passed through either the wet treatment unit or the dry treatment unit.

The gas separation unit comprises a gas semi-permeable membrane on opposite sides of which are defined separate flow paths respectively leading waste gas particles of a certain size to the wet treatment unit and gas particles of a different size to the dry treatment unit.

The wet treatment unit is a chemical bath of KOH, for example, which can neutralize the acidity of such gases as HCl, BCl₃, HBr, Cl, Br and the like. A plurality of separation plates extend alternately from the bottom of the bath vessel toward the top of the vessel and from the top of the vessel toward the bottom. The plates thus are configured to form a flow path through the vessel that causes the waste gas to pass into and out of the chemical bath several times.

The chemicals are refreshed when the pH thereof reaches a certain level, i.e. after the bath is used for some period of time to neutralize the waste gas. A pH sensor and a level sensor are provided for this purpose.

The dry treatment unit comprises a container filled with a dry particulate material, such as soda lime. Therefore, the dry treatment unit can decompose waste gases of the hydride group such as SiH₄, PH₃, AsH₃ or B₂H₆, and the like, into a solid, H₂O, and H₂.

The dry treatment unit includes a plurality of thermocouples spaced apart in the direction of flow through the unit. The temperature of the waste gas as it reacts with the particulate is measured by the thermocouples. This information is used to determine when the particulate material must be replaced or regenerated.

Furthermore, the dry treatment unit has a porous gas line extending in a helix through the particulate. This serves to maximize the area over which the chemical reaction between the waste gas and the particulate can take place.

A toxicity detector is disposed at the end of the water treatment system, i.e., downstream of the water spray unit in order to detect the degree to which the waste gases have been purified. If the detected toxicity of the treated gases remains too high, the toxicity detector generates signals which open a return line leading back into the water treatment system so that the waste gases are recirculated therethrough for further treatment.

### BRIEF DESCRIPTION OF THE DRAWINGS

These and other objects, features and advantages of the present invention will become more apparent from the following detailed description of preferred embodiments thereof made with reference to the accompanying drawings, of which:

FIG. 1 is a schematic diagram of one embodiment of a waste gas treatment system of a semiconductor device fabrication facility according to the present invention;

FIG. 2 is a partially cut-away perspective view of a gas separation unit of the waste gas treatment system according to the present invention; and

FIG. 3 is a partially cut-away perspective view of a dry treatment unit of the waste gas treatment system according to the present invention.

### DETAILED DESCRIPTION OF THE PREFERRED EMBODIMENT

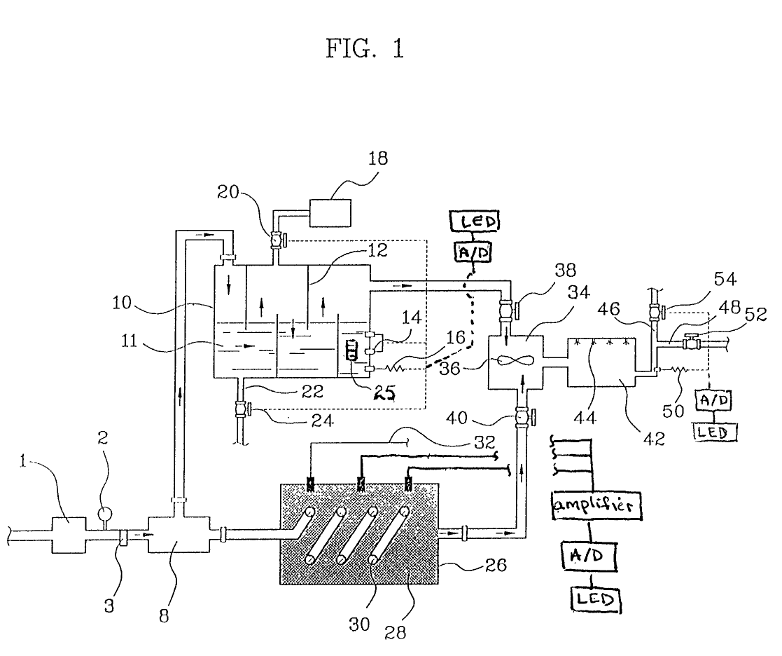

Referring first to FIG. 1, a compressor 1 compresses the waste gas generated as the result of the carrying out of a semiconductor device manufacturing process in a processing chamber/chambers (not shown). After being compressed, the waste gas is induced into a gas separation unit 8. The pressure of the waste gas induced into the gas separation unit 8 is controlled by a pressure regulator 2, and the flow rate is controlled by an MFC (Mass Flow Controller) 3.

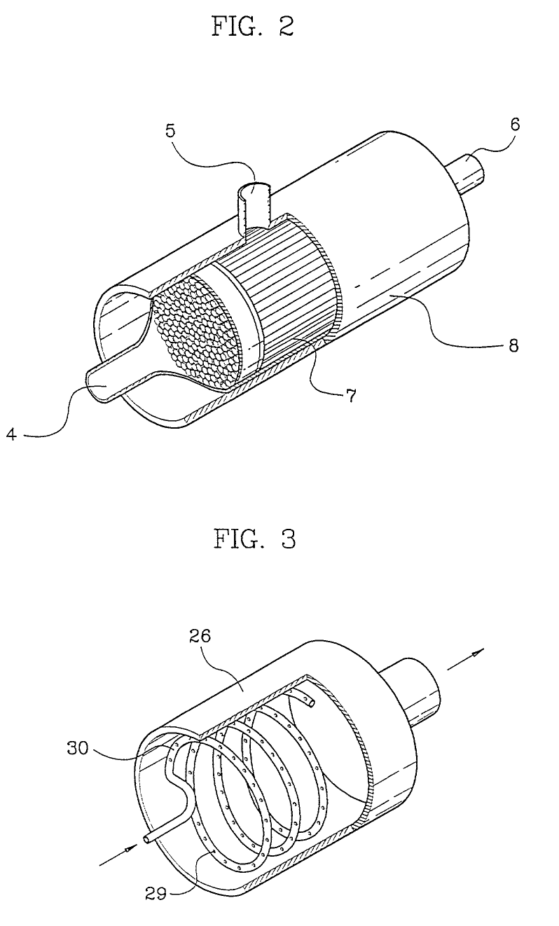

As shown in FIG. 2, the gas separation unit 8 has an inlet 4 leading to a membrane 7, a dry treatment outlet 6, and a wet treatment outlet 5. The membrane 7 separates the gas according to the size of the gas particles. That is, large waste gas particles which can not permeate the membrane 7 flow through the dry treatment outlet 6 to a dry treatment unit 26. On the other hand, the small waste gas particles, which can permeate the membrane flow through the wet treatment outlet 5 to a wet treatment unit 10.

The wet treatment unit 10 comprises a chemical bath of KOH 11. More specifically, the KOH 11 is contained in a vessel partitioned by a plurality of separation plates 12 so as to form a serpentine flow path for the waste gas through the KOH 11. To accomplish this, the separation plates 12 extend alternately from the top and bottom of the vessel. Therefore, the waste gas passes through the KOH 11 a number of times so that it can be completely neutralized.

The wet treatment unit 10 neutralizes highly acidic materials, such as HCl, BCl₃, HBr, Cl, Br and the like in the waste gas. The wet treatment unit 10 has a pH sensor 16 for measuring the pH of the KOH 11, which changes according to the degree to which the waste gas passing therethrough has been neutralized. If the measured value of the pH is above a predetermined value of ten (10), a valve 24 in a drain line 22 leading from the bottom of the vessel of the wet treatment unit is automatically opened to drain the KOH 11. In addition, a valve 20 disposed in-line between a KOH tank 18 and the vessel of the wet treatment unit 10 is automatically opened so that new KOH 11 is supplied to the vessel. The first and second valves 20 and 24 are solenoid operated valves.

The wet treatment unit 10 also includes a level sensor 14 for measuring the amount of KOH 11 in the vessel, whereby a constant amount of KOH 11 can always be maintained in the vessel of the wet treatment unit 10.

Furthermore, the wet treatment unit 10 may also include a pH display 25 comprising an indicator, such as phenolphtalein which indicates the pH of the KOH by the color thereof. In addition, the pH sensor 16 is connected to an analog-digital convertor and an LED for displaying the value of the acidity of the KOH. The LED display makes it possible to determine the acidity of the KOH even at a distance from the wet treatment unit 10.

The dry treatment unit 26 comprises a vessel filled with soda lime through which the waste gas discharged from the outlet 6 of the gas separation unit 8 passes. The soda lime decomposes gases of the hydride group, such as SiH₄, PH₃, AsH₃, B₂H₆, and the like, into a solid product, H₂O, and H₂.

A thermocouple 32 is provided on the top of the vessel of the dry treatment unit 26 to detect heat produced by the decomposition reaction between the waste gas and the soda lime. The thermocouple 32 is thus used to determine when the soda lime 28 should be refreshed. That is, when used for a long period of time, the soda lime 28 loses its ability to decompose the waste gas. When this occurs, little heat is generated. Therefore, the temperature measured by the thermocouple 32 is an indicator of when the soda lime 28 must be replaced.

Since the decomposition reaction occurs throughout the vessel of the dry treatment unit 26, several thermocouples 32 are actually provided as spaced apart by uniform intervals in the lengthwise direction of the dry treatment unit 26. In this way, the decomposition reaction temperature can be measured at several locations spaced equally apart from one another. The temperature signals generated by the thermocouples 32 are amplified by an amplifier, and are shown by an LED display connected to the amplifier and thermocouples 32 by an analog-digital convertor.

As best shown in FIG. 3, the dry treatment unit 26 has a helical gas line 30 having a plurality of pores 29 from which the waste gas passes into the soda lime 28. The pores 29 serve to maximize the area over which the waste gas and the soda lime are exposed to one another 28, which enhances the efficiency of the decomposition reaction. The gas line 30 extends up to two thirds of the way along the length of the soda lime 28 as taken in the direction of flow through the dry treatment unit 26.

A blower unit 34 is disposed in-line with both the wet treatment unit 10 and the dry treatment unit 26 via a first check valve 38 and a second check valve 40, respectively. Therefore, waste gases passing through the wet treatment unit 10 and the dry treatment unit 26 can not flow back thereto. The blower unit 34 comprises fans 36 for blowing the waste gases to a water spray unit 42.

The water spray unit 42 has a plurality of water spray nozzles 44 on its ceiling that spray water over the waste gases passing through the water spray unit 42. The water spray unit 42 treats water soluble waste gases such as NH₃, having a high level of alkalinity. A discharge line 46 of the water spray unit 42 leads the treated waste gases to the atmosphere.

However, a toxicity detector 50 is interposed between the water spray unit 42 and a return line 48 to detect the degree to which the treated waste gases, i.e. those having passed through the wet treatment unit 10 or the dry treatment unit 26, and the water spray unit 42, have been purified. If the detected toxicity level of the treated gases is too great, the toxicity detector 50 sends a signal to a third solenoid valve 54 disposed in the discharge line 46 to close the valve and hence, the line, and opens a fourth solenoid valve 52 disposed in the return line 48 so that the waste gases are returned to the treatment system via the return line 48. Specifically, the return line 48 leads back to the membrane 7 of the gas separation unit 8.

As described above, unlike the conventional method in which the different kinds of processing gases produced as a result of the semiconductor device fabrication process are treated in separate treatment systems, the present invention provides a single system by which all such waste gases may be treated. Accordingly, the installation of the present invention is more economical and efficient compared to the dual installations of the prior art.

Finally, although the present invention has been described in detail above, various changes, substitutions and alterations thereto will become apparent to those of ordinary skill in the art. For instance, although the dry treatment unit 26 has been disclosed as an essentially horizontally oriented unit, the dry treatment unit 26 may be oriented vertically. Accordingly, all such changes, substitutions and alterations are seen to be within the true spirit and scope of the invention as defined by the appended claims.

What is claimed is:

1. A waste gas treatment system of a manufacturing facility, said system comprising:
a wet treatment unit which carries out a wet treatment of waste gases passing therethrough;
a dry treatment unit which carries out a dry treatment of waste gases passing therethrough;
a gas separation unit which discriminates waste gas requiring the wet treatment from waste gas requiring the dry treatment, said gas separation unit having a first outlet connected to said wet treatment unit, and a second outlet connected to said dry treatment unit; and
a water spray unit connected to both said wet treatment unit and said dry treatment unit, said water spray unit comprising a sprayer which sprays waste gas having passed through either the wet treatment unit or the dry treatment unit with water to remove from the waste gas water soluble constituents of the waste gas.

2. The waste gas treatment system of claim 1, wherein said gas separation unit comprises a semi-permeable membrane permeable to gas particles of a predetermined maximum size and impermeable to gas particles of a size greater than said maximum size.

3. The waste gas treatment system of claim 1, and further comprising a compressor connected to and disposed upstream of said gas separation unit with respect to the direction of flow of waste gas through the system.

4. The waste gas treatment system of claim 3, and further comprising a pressure regulator disposed between said compressor and said gas separation unit in order to regulate the pressure of waste gas flowing from said compressor to said gas separation unit.

5. The waste gas treatment system of claim 4, and further comprising flow control means, disposed in-line between said pressure regulator and said gas separation unit, for controlling the flow rate of waste gas flowing from said compressor to said gas separation unit.

6. The waste gas treatment system of claim 5, wherein said flow control means is a flow meter.

7. The waste gas treatment system of claim 5, wherein said flow control means is a master flow controller.

8. The waste gas treatment system of claim 1, wherein said wet treatment unit comprises a vessel, a chemical bath in said vessel, and a plurality of separation plates extending alternately from the bottom of the vessel toward the top of the vessel and from the top of the vessel toward the bottom so as to form a flow path through said vessel that passes into and out of said chemical bath several times.

9. The waste gas treatment system of claim 8, and further comprising a tank of the chemical connected to said wet treatment unit, and a valve disposed in-line between said tank and said wet treatment unit, and wherein said wet treatment unit has a level sensor which detects the level of the chemical bath in said vessel, said level sensor being operatively connected to said valve so as to open said valve when the chemical bath is below a predetermined level to thereby allow chemical from said tank to flow into said vessel and to close said valve when the chemical bath is at said predetermined level, whereby a predetermined amount of the chemical always remains in said vessel.

10. The waste gas treatment system of claim 9, and further comprising a drain line open to the bottom of said vessel of said wet treatment unit.

11. The waste gas treatment system of claim 1, wherein said wet treatment unit comprises a liquid supply of an alkaline for neutralizing the acidity of waste gas passing through said wet treatment unit.

12. The waste gas treatment system of claim 11, wherein said alkaline is KOH.

13. The waste gas treatment system of claim 8, wherein said chemical is KOH.

14. The waste gas treatment system of claim 9, and further comprising a pH sensor immersed in said bath in order to measure the pH of the chemical, said pH sensor being operatively connected to said valve so as to control said valve based on the pH measured by the sensor.

15. The waste gas treatment system of claim 14, wherein said pH sensor issues a signal to open said valve when the pH of the chemical reaches a value of ten.

16. The waste gas treatment system of claim 14, and further comprising a digital display operatively connected to said pH sensor so as to display the value of the pH of said bath.

17. The waste gas treatment system of claim 8, and further comprising an indicator indicating the pH of said bath with its color.

18. The waste gas treatment system of claim 17, wherein said indicator is phenolphtalein.

19. The waste gas treatment system of claim 1, wherein said dry treatment unit comprises a vessel, and a particulate filling said vessel.

20. The waste gas treatment system of claim 19, wherein said particulate is soda lime.

21. The waste gas treatment system of claim 19, wherein said particulate is capable of decomposing gas of the hydride group.

22. The waste gas treatment system of claim 19, wherein said dry treatment unit has at least one thermocouple mounted to the vessel thereof.

23. The waste gas treatment system of claim 22, and further comprising an amplifier connected to said at least one thermocouple, an A/D converter connected to said amplifier, and a temperature display connected to said A/D converter.

24. The waste gas treatment system of claim 19, wherein said dry treatment unit further comprises a helical gas line extending from an inlet of said vessel through said particulate.

25. The waste gas treatment system of claim 24, wherein gas line has a plurality of pores extending therethrough.

26. The waste gas treatment system of claim 1, and further comprising a blower unit interconnecting said wet treatment unit and dry treatment unit to said water spray unit, and check valves disposed in-line between the wet treatment unit and the blower unit and between the dry treatment unit and the blower unit, respectively, whereby waste gas treated in said wet and dry treatment units is prevented from back-flowing thereto.

27. The waste gas treatment system of claim 1, wherein said water spray unit has a ceiling and a plurality of water spray nozzles mounted to its ceiling in order to spray water on the waste gases which have passed through the wet treatment unit and the dry treatment unit.

28. The waste gas treatment system of claim 27, and further comprising a discharge line leading from said water spray unit, a shut-off valve disposed in said discharge line, a return line branching from said discharge line, and a shut-off valve disposed in said return line.

29. The waste gas treatment system of claim 28, and further comprising a toxicity detector interposed between said water spray unit and said return line to detect the level to which the waste gases have been purified, said toxicity detector being operatively connected to said shut-off valve in the discharge line to close the valve when the level of toxicity detected is greater than a predetermined level, and said toxicity detector being operatively connected to said shut-off valve in the return line so as to open the valve when the detected level of toxicity is greater than said predetermined level.

30. The waste gas treatment system of claim 29, and further comprising a display, and an A/D converter connecting said toxicity detector to said display.
